(19) United States
(12) Patent Application Publication
(10) Pub. No.: US 2017/0140046 A1
(43) Pub. Date: May 18, 2017

(54) ELECTRONIC COMPONENT WITH DETERMINISTIC RESPONSE

(71) Applicant: VOOX, Gif sur Yvette (FR)

(72) Inventors: Stéphane ROSE, Gif sur Yvette (FR); Nicolas MALASNE, Villiers sur Marne (FR)

(73) Assignee: VOOX, Gif sur Yvette (FR)

(21) Appl. No.: 15/129,891

(22) PCT Filed: Mar. 26, 2015
(86) PCT No.: PCT/IB2015/052225

§ 371 Date: Sep. 28, 2016

(30) Foreign Application Priority Data
Mar. 28, 2014 (FR) 14 52723

(51) Int. Cl. G06F 17/30; H04L 29/06; H04L 29/08

(52) U.S. Cl. CPC G06F 17/30864; H04L 67/125; H04L 69/08

(57) ABSTRACT

An electronic component with supervised communication modules has: —at least two communication modules functioning in parallel; and —a microprocessor-free supervisor. Each communication module has a step for interfacing with the supervisor, thus enabling the latter to use a data format common to all the modules. The supervisor is configured to deterministically manage access to a database on the basis of a configuration table and requests to read from and/or write to the database, from the communication module.

The present invention relates to electronic components designed to operate in a data processing environment, allowing the exchange of data and communications, in a deterministic manner, between various elements of the environment.

Communications and control electronic systems are becoming increasingly complex. A current automobile may for example comprise up to seventy interoperative electronic control units. There currently exist a total of close to three hundred different communications protocols.

In view of the demands for interoperability and this complexity, users have sought to have a single standard.

The majority of the communications protocols integrate both a communications protocol, or language, and a physical transmission medium. These protocols are thus very dependent on the means used and on the software application targeted, and are incapable of taking into account a change, such as a need to increase the bandwidth or for diversification of the transmission mode, for example wired, wireless, optical or by power line carrier communications (PLC).

It is thus difficult for the current protocols to respond to the demands of the users, notably to keep up with the growing rate of new products and software applications coming to the market and the necessity to integrate heterogeneous elements in order to constitute a competitive environment.

In the multi-protocol context, distributed architectures are increasingly being used. These architectures consist in creating networks of processors and sensors.

The users have also tried to externalize their developments and to search for solutions of the “commercial off-the-shelf” (COTS) type, in other words solutions already available on the market to replace their specific internal developments.

One solution known from the patent application US 2006/036772 is to provide a mediation software operating within a distributed architecture and communicating with a host processor by means of interface modules using software processors. Pre-defined and non-modifiable time slots are imposed for the exchanges between the host processor and the mediation software, using a clock synchronized between the latter.

The application WO 00/03521 describes an Ethernet interface using software modules.

The application WO 2004/059505 provides a software method for sharing data stored in a database. Various software programs can access the database.

These solutions do not allow a universal interaction with the various existing communications protocols while at the same time offering the possibility of transmitting all the data coming from the various streams of an environment in an autonomous, adaptable and deterministic manner. The software solutions must notably manage numerous interrupts during the execution of the programs, a fact which prevents deterministic responses being obtained.

There exists a need to provide an electronic component capable of operating in a distributed environment and of playing the role of a gateway between various elements of the environment using different communications protocols, while at the same time supplying deterministic responses to requests originating from these elements. The invention responds to this need thanks to an electronic component with supervised communications modules, the component comprising:
at least two communications modules operating in parallel, and
a supervisor without a microprocessor, each communications module comprising a stage for interfacing with the supervisor allowing the latter to use a data format common to all of the modules, the supervisor being configured for managing, in a deterministic manner, the access to a database, as a function of a configuration table and of requests for reading and/or writing data coming from the communications modules.

The phrase “in a deterministic manner” should be understood to mean that the component guarantees to always supply a response, to the same request, within a pre-determined maximum time.

The phrase “without a microprocessor” should be understood to mean that the supervisor does not execute any data processing program and does not contain any operating system.

The invention provides a mediation operator, or “middleware”, for real-time and multi-protocol communications, playing the role of a gateway between heterogeneous elements of an external environment using different communications protocols. The component according to the invention relates to a distributed environment, allowing the exchange of data between these various elements with guaranteed real-time performance characteristics.

The invention provides the users with a modular, universal, simple, adaptable and secure solution, capable of being integrated into their existing environments, in order to simplify the management of the data streams and the exchanges of data within these environments. This leads to the reduction in their development and validation times.

The invention allows the user to simplify the developments of complex environments while ignoring the communication, in other words the user can develop the desired application without having to worry about the communications aspects needed for its correct operation. The communications aspects are notably dissociated from the mode of transmission of the data, and the application becomes independent of the communications protocol used in the environment within which the application is being developed. The user can thus easily re-use applications already developed, and make the link between the past and the future while being capable of operating just as well with old communications protocols as with new ones.

The component according to the invention facilitates the management of communications modules, corresponding for example to the link with an application of the environment and/or allowing physical inputs/outputs to be controlled and/or information to be exchanged with other applications via one or more networks, by any transmission means, for example wired, wireless, optical, or by power line communications.

The component according to the invention allows the access to the data to be managed independently of their place of production, elements of the architecture or communications modules of the component according to the invention, and allows it to be guaranteed that the data is made available to the environment within a pre-determined maximum time for a given environment. The supervisor allows concurrent accesses to the database to be managed in a secure and deterministic manner.

The component is advantageously integrated into a target environment without it being necessary to program new lines of computing code. The component is capable of being adapted to any type of operating system, to any type of communications bus for computer boards, for example for the connection with a processor executing an application, and to any type of communications protocol.

The component according to the invention does not define a new communications protocol and is different from a proprietary communications bus.

The component according to the invention does not impose any time constraints on the elements of the environment, for example processors executing applications, the various tasks performed by the component, in response to the data read and/or write requests from the communications modules, not being subject to the allocation of time slots. These tasks are sequenced by the passage of tokens, in other words the component is configured so as to hand over to the next task when the current task is terminated. The events do not need to be time stamped in order to carry out said tasks. The component according to the invention, supplying a deterministic response guaranteeing the control of the propagation times of the signals and the data transmission latencies, and thus their processing times, provides a high level of security and is particularly adapted to critical applications, notably integratable into environments designed for aeronautics or defense, where this type of response is crucial. This feature of predictability is virtually impossible to achieve with the known software solutions, referred to as “layered”, and is increasingly required in the certification procedures for the environments with critical levels of security.

Electronic Component

The component according to the invention is advantageously formed with the aid of one or more programmable logic components, preferably reprogrammable. The component may be formed with the aid of one or more components of the FPGA (field-programmable gate array) type or the CPLD (complex programmable logic device) type or the ASIC (application specific integrated circuit) type.

The component according to the invention is thus based on hardware elements such as logic gates and state machines. These elements are advantageously programmed in VHDL (VHSIC Hardware Description Language) language. Unlike microprocessors or microcontrollers, the programmable logic components, notably of the FPGA type, are intrinsically parallel comprising matrices of millions of transistors, and are thus perfectly adapted to the simultaneous reception and to the simultaneous transmission of several data streams. They furthermore allow the component according to the invention to be rendered much more robust against computer attacks, known as “cyber attacks”, malicious software or “malware”, targeting microprocessor applications, usually being inoperative on a programmable logic component.

The component may comprise a sequencer. This sequencer may be external to the supervisor, being controlled by the supervisor, or integrated into the supervisor. It allows the transmissions of requests and of data originating in parallel from the communications modules to be organized in order of priority. The sequencer allows the data transmission latencies and the data access times to be guaranteed, and collisions between the various requests to be avoided by providing the management of concurrent requests.

The component advantageously comprises a time base configured for adding to a data value its time of receipt by the communications module during a request to write in the database. This time of receipt may be read with the data value during a read request. This allows the environment to manage a duration of validity for each data value, according to the need, and to notably determine whether a data value has become obsolete. The time base can use a system time accurate to 1 μs, coded over 52 bits. It is advantageously available at any given moment. It allows a common time to be made available for all the communications modules of the component.

The parameter setting of the component may be carried out by a software environment called configurator. The parameter setting may be implemented using files describing the data exchange streams together with their type in the environment, for example which element of the environment produces which data value, and which data value is consumed by which elements.

Data and Database

The data managed by the component according to the invention is advantageously identified in a unique manner by an identifier.

The data written in the database can contain several encapsulated parameters, notably the identifier of the data value, the time associated with this data value by the time base and the result of a cyclical redundancy control on the data value, thus creating a metadata value. The cyclical redundancy control allows the integrity of the data value to be validated when it is read. If the data value is altered, the supervisor is configured for reading it in the database, and for sending an error notification to the communications module at the same time as said altered data value.

The encapsulation of a data value is preferably inseparable from the latter and can only be removed during a read access.

The data can be recorded in the database in a format of which one non-limiting example is illustrated in the following table, comprising the identifier (“identifier_{—} data”), the time associated with the data value (“date”), the data value itself (“data”) and the result of the cyclical redundancy control (“crc”):

| | | Database |
|---|---|---|
| Data(31:0) | | address(17:0) |
| Identifier_data | unused(31:12) &identifier_data(11:0) | first_address |
| Date | date(31:0) LSB | first_address + 1 |
| Date | unused(31:20)&[date(19:0) MSB] | first_address + 2 |
| Data | data(31:0) | first_address + 3 |
| . . . | . . . | . . . |
| Data | data(31:0) | first_address + |
| | | 2 + data_size |
| CRC | crc(31:0) | first_address + |
| | | 3 + data_size |

The address of the data value (“first_address”) is advantageously supplied by the configuration table.

The component advantageously communicates with the database via a dual access port, allowing independent accesses to the database for the data value and its address, in order to manage the concurrent accesses to the database and to avoid losses of data in the case of concurrent requests.

The component may comprise the database. In one variant, the database is situated remotely at another location of the environment and is connected to the component, notably via a dual access port and a dedicated interface, in order for the component to be able to control the database.

The addresses of the data in the database are advantageously managed solely by the supervisor, as a function of the configuration table, which allows the accidental overwriting of data to be avoided.

Access to the database advantageously takes place in the form of an interface of the request/data type, in other words the access is obtained by a read or write request and by a frame containing or receiving the data value depending on the direction of the request.

The transfers to and from the database may be defined by an algorithm of the DTDMA (dynamic time-division medium access) type which allocates a maximum transfer time for each access. This algorithm provides a minimum bandwidth between the supervisor and the database. In contrast to other known algorithms, at the same time as complying with the determinism, it allows the data rates to be optimized; for example, if a communications module is alone in wishing to gain access to the database, it can use the whole of the bandwidth.

The storage of the data in the database may be managed according to various stacking modes, determined by a parameter in the configuration table, for example the “first in, first out” (or FIFO) mode, or “last in, first out” (or LIFO) mode.

The characteristics of the database are advantageously chosen according to the desired performance and the cost of the technologies, so as to be adapted to each environment.

The physical medium of the database may be a dual port, static random access memory (or SRAM), in the case where the component comprises the database, or, in the case where the database is external to the component, dynamic (SDRAM for “Synchronous Dynamic Random Access Memory”), for example a DDR (double data rate) memory. The database may have a memory of 32, 64 or 128 bits, a capacity of 1 MByte or more, and a frequency of 125, 200 or 333 MHz or higher.

Configuration Table

The configuration table notably defines the data values contained in the database and their properties.

The configuration table may for example contain at least 2048 data values of 64 bits each. The identifier of the data value to be managed allows access to it.

The configuration table may be generated by the configurator, based on the definition of the environment and of the data by the user. For this purpose, a graphics interface may be used in order to graphically define the topology of the environment, together with the whole set of data. In one variant, XML (for “extensible markup language”) files may be used.

The configuration table can comprise the following configuration information:
the address of the data value in the database (“first_address”),
the size of the data value to be written or read in the database (“data_size”),
the number of data values having the same identifier, stackable in the database (“data_number”),
the mode of management of the stack in the database (“stack_mode”),
the pointer (“writing_current_number”) to the last data value with a size “data_number” written in the database, this pointer being advantageously updated at each read or write in the database,
the pointer (“reading_current_number”) to the last data value with a size “data_number” read in the database, this pointer being advantageously updated at each read or write in the database,
an indicator (“producer”) of the access ports able to produce the data to be written in the database, coded over 8 bits with one bit per port (bit equal to 0: the port is not associated with the identifier of the data, bit equal to 1: the port is associated with the identifier of the data),
an indicator (“consumer”) of the access ports able to consume the data read in the database, coded over 8 bits with one bit per port (bit equal to 0: the port is not associated with the identifier of the data, bit equal to 1: the port is associated with the identifier of the data),
a bit indicating whether the data value to be managed must be distributed to another element of the environment or not (“remote_consumer”),
a bit indicating whether the modules consuming the data have to be informed of the writing of said data or not (“consumption_enable”), and
a bit indicating whether the modules producing the data have to be informed of the reading of said data or not (“consumption_acknowledge”).

This information is illustrated in the following table:

The component may comprise the configuration table. In one variant, the configuration table is situated at another location of the environment and is connected to the component, notably via an access port. The configuration table may be stored on a memory of the Flash or SRAM or SDRAM type.

The configuration table is preferably an entity distinct from the database.

The response time of the component to each request originating from the communications modules can be calculated by means of a dedicated software application, for example based on information from the configuration table, notably based on the length of the data frames corresponding to the request.

Supervisor

The supervisor is advantageously configured for real-time operation. It allows the link to be made, in real time, between the local memory of the environment, which stores the data, and the events originating from the various communications modules.

Preferably, the supervisor does not depend on the physical medium of the database, and is configured independently of the latter.

The supervisor preferably receives the requests from the environment and enables the operation of the component according to the invention irrespective of the operating system or systems used by the environment and the communications buses used.

The supervisor may be connected to a third-party software application using an application programming interface (or API), comprising a set of commands to enable the component according to the invention to execute various instructions. This set of instructions notably comprises elementary data read and write commands, and commands managing the configuration of the environment, the events of the component according to the invention, such as the control of the latter, for example the access to information on its state and to information on acknowledgements of commands, and the services offered by the component, for example its start-up and its shutdown after its configuration, or the access to the system time.

The application programming interface may be situated within a host processor to which the component according to the invention is connected, notably via a communications module.

The application programming interface can comprise between 8 and 15 commands, notably 10 commands. This interface is advantageously sufficiently generic for the installation of the supervisor to be applicable to any type of operating system.

The parameters of the supervisor are preferably totally adjustable in order to be adaptable to the heterogeneity of the modules connected to it.

The supervisor is advantageously functionally invariant within an environment or from one component to another. The configuration table is advantageously configured to be adaptable/upgradable according to the desired application, a fact which permits the invariance of the supervisor. The supervisor is furthermore advantageously independent of the number of communications modules present in the component and of the nature of the latter. The adaptability/upgradability of the component is thus possible according to the needs of the environment.

The supervisor is advantageously configured for verifying the validity of a data read and/or write request by means of the identifier associated with said data value. The supervisor can thus be aware, by means of the configuration table, of the properties of each data value thanks to its identifier. The supervisor can thus be configured for verifying the size of the data value during each read or write request.

The supervisor may be configured, after writing and/or reading a data value in the database, and as a function of the configuration table, for transmitting a notification to the communications module from which the request for reading and/or writing said data value originates, notably a notification of success or of an error.

The supervisor may have access to a command register, allowing the component to be controlled via the application programming interface. The commands in the command register notably manage the initialization and the shutdown of the component.

The supervisor may have access to a monitoring register notably containing information on the state of the component and error reports on previous requests. This enables the implementation of operational safety and security mechanisms, allowing the component to be used in critical applications subject to essential certification requirements.

Communications Modules

Each communications module of the component according to the invention advantageously furthermore comprises a stage for interfacing, externally, with an element of the environment, and a link stage between this stage for interfacing to the external environment and the stage for interfacing with the supervisor, allowing the management and the transmission of the data read and/or write requests. The interfacing stages of the communications modules allow the processing of data having different formats as a result of originating from different elements of the same environment, for example the avionics bus or the radar of a drone.

The communications modules may be re-used from one environment to another or for various different applications. A library of modules can thus be created. An already existing module may also be adapted for another purpose or for another application.

The communications modules may be configured for transmitting the data read and/or write requests to the supervisor via access ports. These access ports are advantageously identical irrespective of the communications module to which they are connected and may be controlled by the supervisor.

The read and/or write requests preferably originate from demands on the environment received by the communications modules, notably a demand on at least one software application executed on a processor of the environment, notably a microprocessor, and/or from a physical input/output of the environment, notably an audio and/or video input/output, and/or from a network of the environment, notably a CAN, a TCP-IP network, a network using the standards ARINC 429, AFDX, MIL STD 1553, or FlexRay, or the Ethercat or Powerlink system.

Processor

At least one of the communications modules of the component according to the invention may be a processor module, notably enabling the connection with a processor of the environment executing a software application.

This processor module may transmit a request and data to the supervisor during a request to write in the database. It may transmit the data to the environment during a read, and the notification of success of the supervisor where relevant.

The processor module may be connected to at least one communications bus of the processor, this bus being notably a bus using the PCI (peripheral component interconnect) or PCI Express, or a VME bus (VERSA module eurocard) standard.

The processor module advantageously comprises a stage for interfacing with said communications bus, allowing the physical connection with the bus to be made and the requests to be received, and a link stage between this stage of interfacing and the stage of interfacing with the supervisor, allowing the management of the received requests and their transmission to the supervisor via the stage for interfacing with the supervisor, in order to prepare the data frames for their transfer to and from the database.

Input/Output

At least one of the communications modules may be an input/output module, notably allowing a link with a physical input/output of the environment to be established. The physical inputs/outputs of the environment may be of the analog, discrete, RS232 or PT100 type.

The input/output module is advantageously autonomous, in other words once its parameters have been set up, it generates the requests and transmits them to the supervisor without any processor carrying out any particular processing.

The input/output module may comprise a stage for interfacing with at least one physical input/output of the environment, enabling the physical access to this input/output and the data to be transmitted or received to/from the stage for interfacing with the supervisor. This stage for interfacing with at least one physical input/output of the environment may be configured for accessing an analog/digital converter connected to the physical input/output.

The input/output module may furthermore comprise a link stage between this interfacing stage and the stage for interfacing with the supervisor, allowing the requests to be generated in the correct format based on the parameter settings of the module and allowing them to be transmitted to the stage for interfacing with the supervisor.

Network

At least one of the communications modules may be a network module, notably allowing the exchange of data between the component and the environment via one or more networks.

The network module can collaborate with any type of network, for example a CAN, a TCP-IP (“transmission control protocol” and “internet protocol”) network, for example for video streams, a network using the aeronautical standards ARINC 429, AFDX, or MIL STD 1553, the FlexRay standard, or the Ethercat (Ethernet for control automation technology) system, and may correspond to the various standardized communications protocols.

The network module allows a gateway between the network of the environment and the component according to the invention to be implemented, while at the same time managing all the communications issues, such as the segmentation of the data, compliance with the protocols, the decoding or format conditioning of the data.

The network module may not have a processor, being purely hardware, in the case notably where the protocol for the network of the environment allows a bijection with an identifier of a data value to be readily defined. In one variant, the network module can use a processor in order to manage the communications protocol and/or the format conditioning of the data and/or the bijection with the identifier of the data. The code of the processor may be configured so as to be modified according to the desired applications.

The network module may comprise a stage for interfacing with at least one network of the environment, allowing the physical connection to the network to be made, and a link stage between this interfacing stage and the stage for interfacing with the supervisor, allowing the communications protocols of the network to be interpreted and the requests to be transmitted to the stage for interfacing with the supervisor.

The link stage is advantageously configured for converting the data to be processed into a suitable format for the network and for recovering, where relevant, the label or labels from the network corresponding to the identifier of the data, by virtue of a table of correspondence between identifiers and labels of the network, notably initialized at the configuration of the module.

The network module of a component can allow data to be transmitted to the network module of another component according to the invention within the same environment. This allows several components according to the invention to be grouped in order to form an assembly of components.

The component according to the invention may comprise several network modules, notably enabling the connection to be made between various networks of the environment within which the component is being developed, and optimized and deterministic processing times to be provided.

The component may comprise between 0 and 12 network modules, or better between 2 and 8 network modules.

Distribution

At least one of the communications modules may be a distribution module, notably allowing databases of various components according to the invention to be connected together.

This distribution module advantageously plays the role of a distribution bus for the data coming from the database.

The distribution module may comprise a stage for interfacing with at least one connection network of the environment. This interfacing stage allows the physical connection to be made between the various components. The distribution module may furthermore comprise a link stage between this interfacing stage and the stage for interfacing with the supervisor, allowing the management of the communications protocol of the hub and the transmission of the requests to the stage for interfacing with the supervisor. The distribution modules are connected by means of a hub.

The hub connecting the distribution modules of various components according to the invention may use an Ethernet physical medium, for example a copper medium, notably with redundancy, in other words the elements of the medium are systematically doubled up. The distribution module is thus advantageously configured for transmitting and receiving the data over the two branches of the medium in parallel. This allows the transfer of the data to be made secure. If one of the two branches no longer responds, the data value advantageously continues to be received or transmitted.

The state of the hub may be known at any time by the component by means of the monitoring register, which allows it to act quickly in the case of a fault.

The distribution module may distribute the data at 1 Gb/s, or at 10 Gb/s, or via power line communications.

The component according to the invention may comprise between 0 and 12 communications modules, or better between 2 and 8 communications modules.

Any combination of communications modules is possible, which allows a multitude of different components according to the invention to be created.

Safety and security of operation Depending on the needs of the external environment, mechanisms integrated into the component according to the invention may be installed in order to detect a component not complying with the communication rules within the environment, for example reading in parallel with the component the information received and transmitted in order to verify its correct operation, by notably feeding back information to the application programming interface.

Method of Operation of the Component

A further subject of the invention is thus a method of operation of an electronic component according to the invention, comprising at least two communications modules and a supervisor, each communications module comprising a stage for interfacing with the supervisor, in which method:
one of the communications modules of the component transmits a data read and/or write request to the supervisor of the component, via the stage for interfacing with the supervisor, and
the supervisor, as a function of a configuration table, manages in a deterministic manner the access to a database in order to read in it and/or to write in it said data.

The configuration table may be established as a function of the environment and loaded during the initialization of the component, by using the application programming interface or otherwise, for example by means of a processor or distribution module. In one variant or in combination, it may be modified later on, depending on the variations over time of the environment and the desired applications.

Before writing or reading a data value in the database, the supervisor advantageously verifies the validity of the request for reading and/or writing said data coming from a communications module, notably by means of an identifier corresponding to the parameters of the configuration table, such as previously described.

Method of Fabrication of the Component

Yet another subject of the invention is a method of fabrication of an electronic component with supervised communications modules according to the invention, comprising at least two communications modules and a supervisor without a microprocessor, in which method one or more programmable logic components, notably of the FPGA, CPLD or ASIC type, are programmed in such a manner that the communications modules operate in parallel and that the supervisor manages the access to a database in a deterministic manner, as a function of a configuration table and of requests to read and/or write in the database coming from the communications modules.

Use of the Component

Yet another subject of the invention is the use of an electronic component with supervised communications modules according to the invention in an aircraft, notably for the control of a radar system or an altimeter, or in an industrial monitoring and control system, for example for the feedback of information coming from sensors, notably for temperature or for speed of rotation, to the supervision applications.

Assembly of Components

Yet another subject of the invention is an assembly comprising several electronic components according to the invention, said components each comprising at least one distribution module and being connected together via their distribution module.

Each component of the assembly according to the invention is advantageously configured for transmitting a data value, following a read request, in the direction of another component of the assembly, configured for writing this data value in the database in the case of a write request. The first component may be called transmitter component, the second receiver component.

Each supervisor of each of the components may be connected to an application programming interface. In one variant, only one supervisor or only a few may be connected to an application programming interface.

A time base is advantageously shared between all the components. The sharing of the time is advantageously dynamic, as a function of the needs of each component. One of the components of the assembly, called “manager component”, is advantageously configured for controlling the synchronization of the dates of all the components by means of the time base shared between all the components. This allows a distributed system time to be set up. The manager component may be configured for periodically sending its system time over the distribution network, each component of the assembly receiving this time and compensating the value received with the latency of the distribution.

The various write or read requests received by the various components may thus be ordered according to an order of priority defined in the configuration table for each component.

The components of the assembly according to the invention advantageously take their turn in the assembly to respond to the requests being addressed to them, in such a manner that, at a given moment in time, only one component is active and the other components are only listening. This allows any data exchange collisions to be avoided.

The manager component may furthermore be configured for listing the connected supervisors of the assembly at a given moment in time.

Any of the components of the assembly may be elected as manager. If the manager is disconnected, because for example of a fault in the component, in the environment or in the network, for example because of the total physical rupture of the link between the hub and this component, a new component can be elected as manager. This re-election is advantageously carried out within a period of time less than or equal to 150 μs, for example for distribution modules using an Ethernet physical medium. The interruption of service is thus very limited, and only has a very small impact on the operation of the environment.

A component disconnected from the assembly is advantageously no longer accessible to the other components, the assembly nevertheless remaining operational. In the case where this component is connected to an application programming interface, it remains advantageously active while at the same time being isolated from the rest of the assembly. In the case where it is the only component connected to an application programming interface, the remainder of the assembly is advantageously no longer connected to, nor controlled by, an application programming interface.

The supervisor of each component is preferably configured for managing the access to a separate database. The data contained in the database associated with a component may be configured so as to be accessible to all the components, notably by means of information coming from the configuration table. This allows the data to be efficiently distributed between the various components of the assembly according to the invention. This also allows it to be ensured that the transfer of a data value has been carried out in a valid manner, by verifying that the encapsulation of a data value received by a receiver component corresponds to the encapsulation at the transmitter, notably the result of the cyclical redundancy control.

The hub may be arranged for detecting a malfunction in one of the components of the assembly, for example a component sending unsolicited or erroneous data; this data will be able to be rejected by the other components.

The programming interface or interfaces may be configured for detecting a fault or a malfunction of the hub, for example continuously sending data to the components in the absence of a request, or an erroneous transmission. The components could then be left active but with an isolated operation, or could be disabled.

A deterministic transfer of the data between components within the same environment is thus ensured by virtue of the distribution modules, allowing independence between the place of transmission and the place of reception of a data value, with no impact on the applications of the external environment. The distribution process is thus managed in an autonomous manner.

The assembly of components according to the invention is equivalent to a communications space operating as a single supervisor macro managing a distributed database.

Method of operation of the assembly Yet another subject of the invention is a method of operation of a assembly comprising several components according to the invention, said components each comprising at least one distribution module and being connected together via their distribution module, in which method:
following a request for writing a data value from one of the communications modules of a component, and as a function of the configuration table, the distribution module of the component in question transmits the data value to all the communications modules of the components, and
the components associated with the identifier of said data value receive it by means of a write request coming from their distribution module.

The supervisors may send a notification to the other communications modules of the component to which they belong in order to inform said modules of the availability of said data value, upon a request expressed by means of a parameter of the configuration table.

The configuration tables for each component may be loaded via a single input component.

The invention will be better understood upon reading the detailed description that follows of exemplary non-limiting embodiments of the latter, and upon examining the appended drawings, in which:

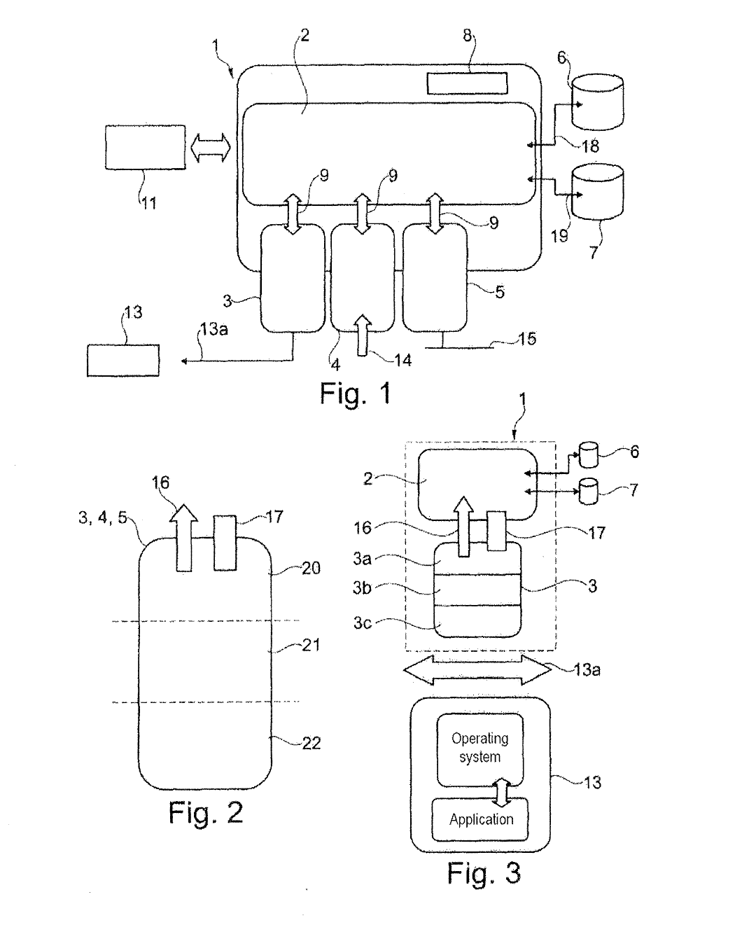

FIG. 1 shows an electronic component with supervised communications modules according to the invention,

FIG. 2 shows the structure of a communications module of a component according to the invention,

FIG. 3 illustrates the operation of a processor module of a component according to the invention,

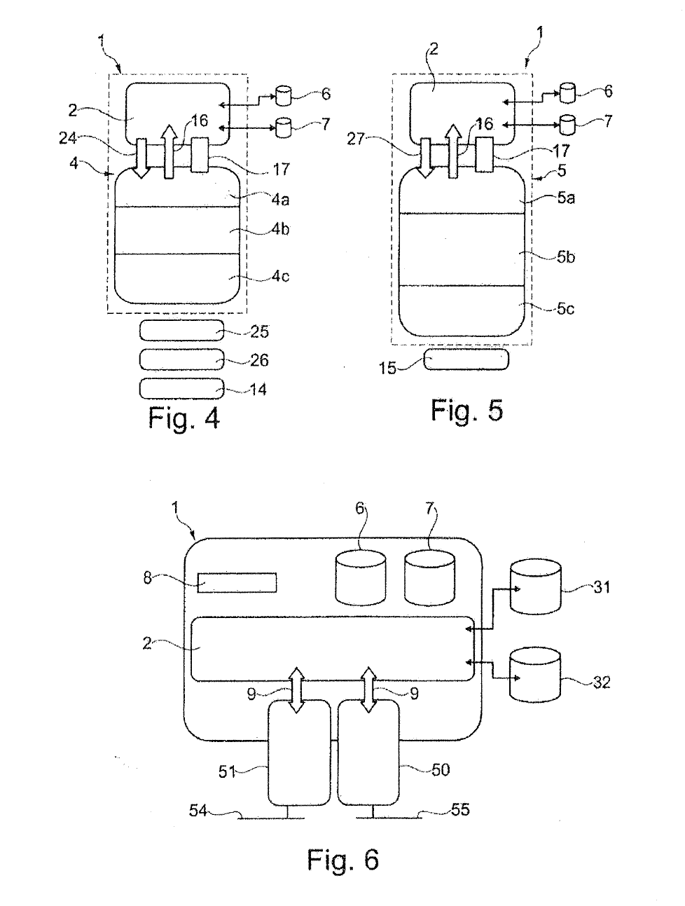

FIG. 4 illustrates the operation of an input/output module of a component according to the invention,

FIG. 5 illustrates the operation of a network module of a component according to the invention,

FIG. 6 shows one variant embodiment of a component according to the invention,

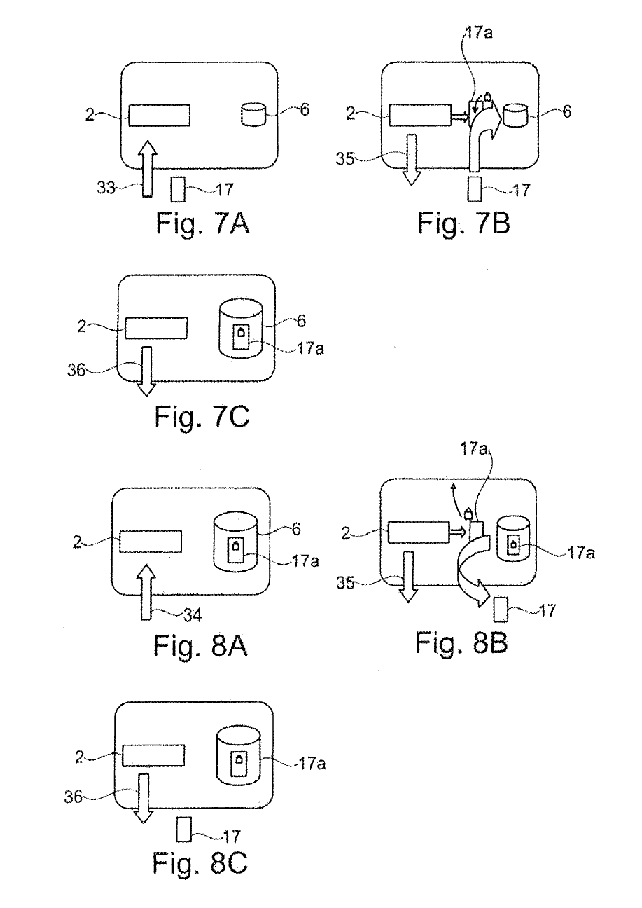

FIGS. 7A to 7C illustrate various steps for writing a data value in the database,

FIGS. 8A to 8C illustrate various steps for reading a data value in the database,

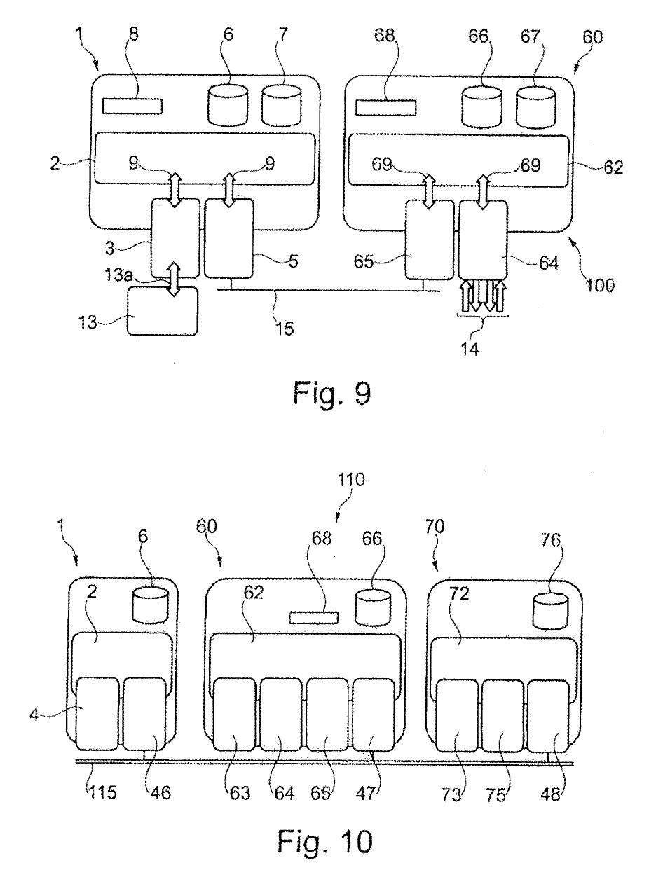

FIG. 9 shows an assembly of components according to the invention,

FIG. 10 shows one variant embodiment of an assembly of components according to the invention,

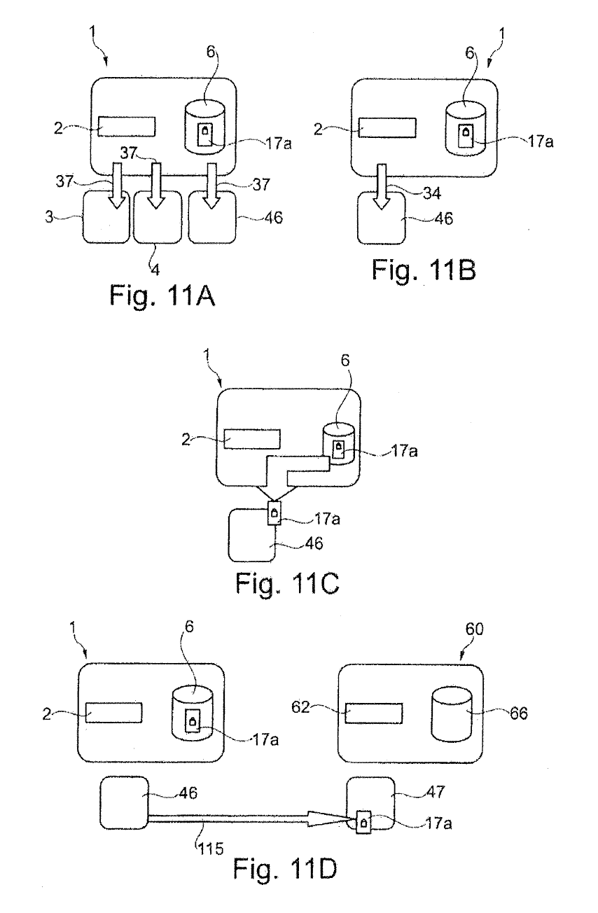

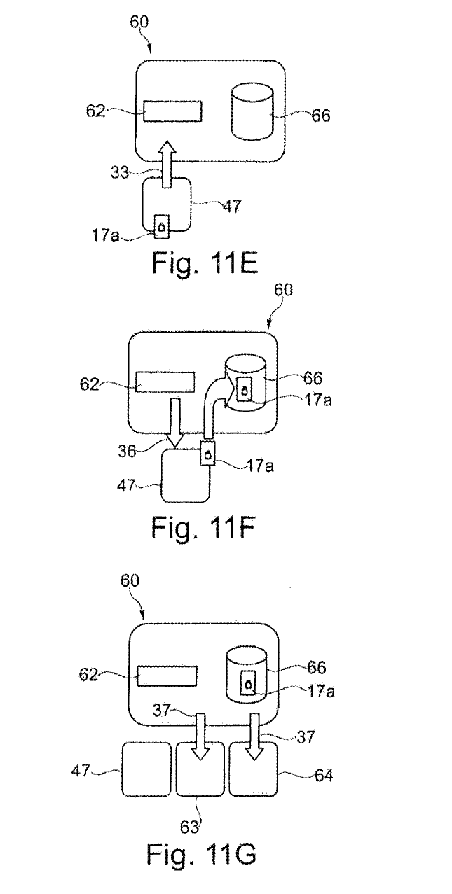

FIGS. 11A to 11G illustrate various steps for distribution of a data value within an assembly of components according to the invention, and

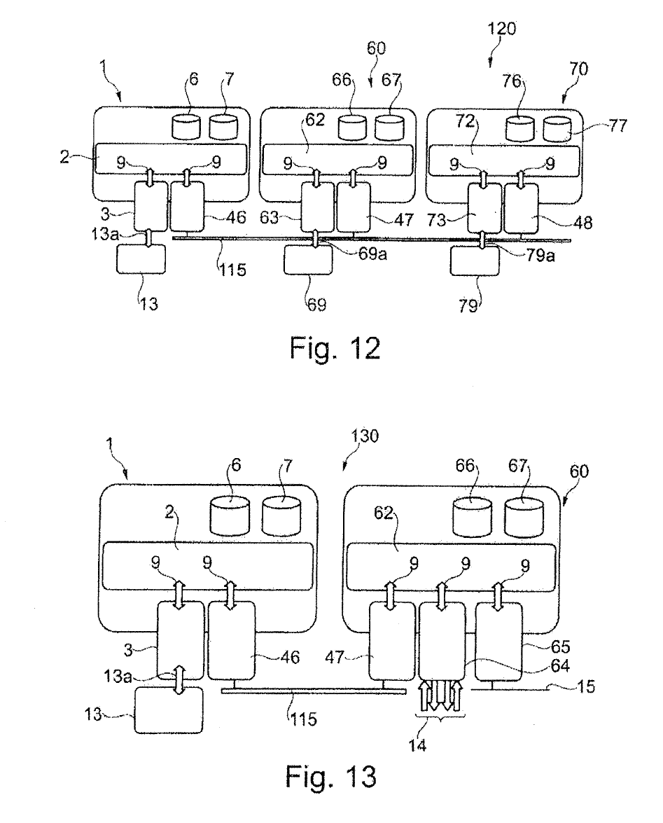

FIGS. 12 and 13 show variants of an assembly comprising several components according to the invention.

An electronic component 1 with supervised communications modules according to the invention, being developed within an external data processing environment, is shown in FIG. 1. This component 1 comprises a supervisor 2 without a microprocessor and three communications modules 3, 4, 5 operating in parallel. The component 1 according to the invention is advantageously formed with the aid of one or more programmable logic components, for example FPGA components.

The supervisor 2 is configured for managing, in a deterministic manner, the access to a database 6, as a function of a configuration table 7, such as previously described, and of requests to read and/or to write in the database 6, coming from the communications modules 3, 4 and 5.

The communications modules 3, 4 and 5 are configured for transmitting the data read and/or write requests to the supervisor 2 via access ports 9 internal to the component 1.

The component 1 advantageously comprises a sequencer, not shown, controlled by the supervisor and allowing the requests coming from the communications modules 3, 4 and 5 operating in parallel to be ordered.

As shown in FIG. 1, the component 1 comprises a time base 8 allowing the adjunction to a data value of its time of receipt by the supervisor 2 during a request to write in the database 6, said time of receipt being notably read with the data value during a read request.

The supervisor 2 is advantageously connected to an application programming interface 11, notably via a communications module, comprising a set of commands to enable the component 1 according to the invention to execute various instructions. This set of commands notably comprises elementary data write and read commands.

As shown in FIG. 2, each communications module 3, 4, and 5 comprises a stage 20 for interfacing with the supervisor 2, allowing the latter to use a data format common to all the data. Each communications module 3, 4, and 5 furthermore comprises a stage 22 for interfacing to an element of the external environment of the component 1, and a link stage 21 between this interfacing stage 22 and the stage 21 for interfacing with the supervisor 2, allowing the management and the transmission of the read and/or write requests 16 and of the data 17.

The read and/or write requests originate from demands on the external environment received by the communications modules 3, 4 and 5.

In the example in FIG. 1, the component 1 comprises a processor module 3, receiving demands on a software application executed on a microprocessor 13 of the external environment, an input/output module 4 enabling the connection with a physical input/output 14 of the environment, and a network module 5 allowing the exchange of data between the component 1 and the environment via a network 15.

The operation of the processor module 3 is shown in detail in FIG. 3. In the example being considered, the microprocessor 13 uses a communications bus 13a of the 32-bit PCI type, and is for example inserted in a computer operating with the Linux operating system. This processor module 3 is configured for transmitting a request 16 and data 17 to the supervisor 2 during a request to write in the database 6. It can transmit the data 17 to the environment during a read request.

The processor module comprises, in the example described, a stage 3c for interfacing with the communications bus 13a, allowing the physical connection with the bus to be made and the write and/or read requests 16 to be received, and a link stage 3b between this interfacing stage 3c and the stage 3a for interfacing with the supervisor 2, allowing the management of the requests received and their transmission to the supervisor 2 via the interfacing stage 3a, in order to prepare the data frames 17 for their transfer to and from the database 6.

The operation of the input/output module 4 is shown in detail in FIG. 4. In this example, the physical input/output 14 of the environment is analog, being for example an input/output value of temperature. In the example described, the stage 4a for interfacing with the supervisor 2 of the input/output module 4 is arranged for transmitting the requests 16 notifying the module 4 to generate a data output 17 by a stream 24 or to sample a data input.

In the case of a read request 16, the data value is acquired by the link stage 4b between the interfacing stage 4a and the stage 4c for interfacing to the input/output of the environment 14, the link stage 4b converting the data value 17 into an appropriate format. The data 17 is subsequently supplied to the interfacing stage of 4c, which effects the physical access to an analog/digital converter 25 in order to transmit the data value 17 in an analog format interpretable by the physical input/output 14 of the environment, by means of a de-coupler/connector 26.

In the case of a write request 16, this request and its associated data value 17 are acquired by the link stage 4b between the interfacing stage 4a and the stage 4c for interfacing to the input/output of the environment 14 which samples the data 17 contained in the analog/digital converter 25 via the interfacing stage 4c. The data is subsequently converted to a suitable format and the request to write in the database 6 is generated and transmitted to the supervisor 2 via the interfacing stage 4a.

The operation of the network module 5 is shown in detail in FIG. 5. In this example, the network 15 of the environment is a network using the Arinc 429 standard. The network module 5 connects on one side to the supervisor 2 of the component 1 and, on the other, to the bus 15 of the Arinc 429 type.

In the example being considered, and in the case of a transmission of data coming from the component 1, during a read request 16, the stage 5a for interfacing with the supervisor 2 transmits the event 27 notifying the network module 5 that a data value is ready to be sent to the bus 15. The event 27 and the data value 17 are acquired by the link stage 5b between the interfacing stage 5a and the stage 5c for interfacing to the network. This link stage 5b is configured for converting the data value 17 into a suitable format for the network 15 and, by virtue of a table of correspondence initialized at the configuration, for acquiring the label or labels of the network 15 corresponding to the identifier associated with the data value 17. The Arinc data frame thus composed is subsequently advantageously supplied to the stage 5c for interfacing to the network 15, which effects the physical access to the bus used by the network 15 while complying with the communications protocol.

In the case of a reception of data by the component 1 coming from the environment, the stage 5c for interfacing to the network 15 acquires the Arinc data frame and supplies it to the link stage 5b between the interfacing stages 5a and 5c. The link stage 5b extracts the useful data value from the frame and, thanks to the table of correspondence between the identifiers of the data and the labels of the network, generates a write request 16 for the corresponding identifier. The stage 5a for interfacing with the supervisor 2 transmits this request to the supervisor 2 which allows the data value 17 to be written into the database 6.

In the variant shown in FIG. 6, the component 1 according to the invention comprises two network modules 50 and 51, allowing a gateway to be established between two networks 54 and 55 in order to exchange data in the environment. In the example being considered, the network 54 is a network using the AFDX standard and the network 55 is a network of the TCP/IP type at 100 Mbps.

In the example in FIG. 6, the supervisor 2 is automatically enabled at the power-up of the component 1. The supervisor 2 also has access, in this example, to a monitoring register 32, notably containing information on the state of the component 1 and error reports on previous requests.

In the example being considered, the component 1 comprises the database 6 and the configuration table 7. In the variant in FIG. 1, the database 6 and the configuration table 7 are situated remotely at another location of the environment, and are connected to the component 1 via dedicated interfaces.

The writing of a data value 17 in the database 6 is described with reference to FIGS. 7A to 7C.

As shown in FIG. 7A, the supervisor 2 receives a write request 33 coming from a communications module, not shown, which has previously prepared the data value to be written. The supervisor 2 is configured for verifying the validity of the request by means of the identifier associated with the data value 17, as a function of the configuration table 7 (not shown).

In the example described, the request is valid and the supervisor 2 notifies the module from which the data value 17 originates that the access is authorized by a notification 35, as shown in FIG. 7B. The module then carries out the transfer of the data value 17 to the database 6. During this transfer, the data value 17 is encapsulated, as previously described.

As shown in FIG. 7C, the encapsulated data value 17a is written in the database 6. The supervisor 2 notifies the error monitoring register 32 of any transfer error by a notification 36.

The reading of a data value 17 in the database 6 is described with reference to FIGS. 8A to 8C.

As shown in FIG. 8A, when the supervisor 2 receives a read request 34 coming from a communications module (not shown), it verifies the validity of the request, just as in the case of a write request, as a function of the configuration table 7 (not shown). In the example described, the request is valid and the supervisor 2 notifies the module from which the request 34 originates that the access is authorized by a notification 35, as shown in FIG. 8B. The supervisor also carries out the transfer of the data value 17 to the communications module, while verifying the integrity of the data.

At the end of transfer, as shown in FIG. 8C, the supervisor may send, upon request expressed via a parameter of the configuration table, a notification 36 on status to the module from which the request originates, as a function of the configuration table 7, in order to notify it of the end of the transfer or a potential error during the latter. The data value 17 is then ready to be used by the communications module.

As shown in FIG. 9, two components 1 and 60 according to the invention may be grouped so as to form an assembly 100 of components. The components 1 and 60 each comprise, in the example described, a network module 5 and 65 connected via a network 15 of the external environment using the AFDX standard.

The component 1 also comprises a processor module 3 connected via a communications bus 13a to a processor 13 of the environment, for example a computer operating under the Windows operating system. The component 60 furthermore comprises an input/output module 64 comprising two input channels and two output channels leading to physical inputs/outputs 14 of the environment.

After a write request coming from the processor module 3 of the component 1, a data value may be written in the database 6 by the supervisor 2 of the component 1. According to the configuration table 7, the supervisor 2 sends a notification signaling the writing of the data value to the network module 5 of the component 1, which is configured for acquiring the data value and transmitting it over the network 15.

The network module 65 of the second component 60 acquires the data value, in the example described, and requests the supervisor 62 to write it in the database 66 associated with the component 60. The supervisor 62 sends a notification to the input/output module 64 which can acquire the data value and transform it in order to transmit it on an output 14 of the environment, as previously described.

In the variant shown in FIG. 10, the three components 1, 60 and 70 according to the invention each comprise a distribution module 46, 47, 48.

The distribution modules 46, 47, 48 comprise, in the example being considered, a stage for interfacing with a connection network 115 of the external environment, connected to a hub. The distribution modules 46, 47, 48 furthermore comprise a stage for interfacing with the respective supervisors 2, 62 and 72 of the components 1, 60 and 70, and a link stage between these two interfacing stages, allowing the management of the communications protocol and the transmission of the requests to the stage for interfacing with the supervisors 2, 62 and 72.

As shown in FIG. 10, the three components 1, 60 and 70 are connected via their distribution module 46, 47, 48 in order to form an assembly 110 of components according to the invention. The stage for interfacing the modules with the connection network 115 of the environment allows the physical connection between the various components to be implemented.

The hub 115 connecting the distribution modules 46, 47, 48 of the components 1, 60 and 70 together uses, in the example described, an Ethernet physical medium with redundancy.

In the example being considered, the component 1 furthermore comprises an input/output module 4. The component 60 comprises a processor module 63, an input/output module 64 and a network module 65. The component 70 comprises a processor module 73 and a network module 75.

One of the components of the assembly 110, the component 60 in the example illustrated, is advantageously configured for controlling the synchronization of the dates of all the components by means of a time base 68 shared between all the components. The data contained in the database associated with a component of the assembly 110 is advantageously configured so as to be accessible by all the components, notably by means of parameters contained in the configuration table 7.

Each component 1, 60, 70 of the assembly 110 is advantageously configured for sending a data value, after a write request, in the direction of another component of the assembly, configured for writing this data value in the database. In the example described, the component 70 receives a data value coming from its processor module 73, and re-distributes it to the processor module 63 of the component 60, which will use it for the application to which it is connected, and to the input/output module 4 of the component 1, which will direct it toward a physical output of the environment.

The various write or read requests received by the various components 1, 60, 70 may be ordered according to their order of arrival and according to an order of priority defined in the configuration table for each component. The components 1, 60, 70 of the assembly 110 can thus take their turn in the assembly to respond to the requests being addressed to them.

One example of distribution of a data value 17 within an assembly 110 comprising two components 1 and 60 according to the invention is illustrated in FIGS. 11A to 11G.

After an encapsulated data value 17a has been written in the database 6 associated with the component 1 of the assembly 110, as previously described with reference to FIGS. 7A to 7C, the supervisor 2 of the component 1 sends a notification 37, if requested, by means of a dedicated parameter of the configuration table 7, to the communications modules 3, 4 and 46 of the component 1 in order to inform it that a data value 17 has been written in the database 6, as shown in FIG. 11A. In the example described, the component 1 comprises, aside from the distribution module 46, a processor module 3 and an input/output module 4.

The distribution module 46 being configured, in the example described, for distributing the data value 17 as soon as it has been written, the supervisor 2 sends a write request 34 to the consumer component via the distribution link 46, as shown in FIG. 11B. In a step shown in FIG. 11C, the encapsulated data value 17a is transferred from the database 6 to the distribution module 46.

As shown in FIG. 11D, the distribution module 46 of the component 1 sends the encapsulated data value 17a over the hub 115 to the distribution module 47 of the other component 60 of the assembly 110. In the example described, since the supervisor 62 of the component 60 is intended to receive the data value 17 according to its identifier, the distribution module 47 of the component 60 thus sends a request 33 for writing the data value 17 to the supervisor 62, as shown in FIG. 11E.

The encapsulated data value 17a is written in the database 66 associated with the component 60 in a step illustrated in FIG. 1 IF. The supervisor 62 sends a notification 36 of status to the distribution module 46, as a function of the configuration table 67 associated with the component 60 (not shown), in order to notify it of the end of the writing of the data value 17 in the database 66 or a potential error during the latter.

The supervisor 62 of the component 60 is advantageously configured for sending a notification 37, if requested, by means of a parameter of the configuration table 7, to the other communications modules of the component 60, a processor module 63 and an input/output module 64 in the example described, in order to inform them that a data value 17 has been written in the database 6 and is thus available, as shown in FIG. 11G.

In the variant of assembly of components according to the invention shown in FIG. 12, the assembly 120 comprises three components 1, 60 and 70, connected together via their distribution module 46, 47, and 48, all three connected to the hub 115 of the external environment, an Ethernet physical medium with redundancy in the example being considered.

The component 1 furthermore comprises a processor module 3 connected via a communications bus 13a to a processor 13 of the environment, which is a computer operating under the VxWorks 5.5 operating system in the example described. The component 60 comprises a processor module 63 connected via a communications bus 69a to a processor 69 of the environment, which is a computer operating under the Linux operating system in the example described. The component 70 comprises a processor module 73 connected via a communications bus 79a to a processor 79 of the environment, which is a computer operating under the Windows XP operating system in the example described.

Each supervisor 2, 62, 72 of each component 1, 60, 70 constituting the assembly 120 is advantageously interfaced with the corresponding processor 13, 69, 79, by means of the processor modules 3, 63, 73 connected to the hub 115 by virtue of the distribution modules 46, 47, 48.

This variant provides a distributed architecture of computers, referred to as a “cluster”, in which each application hosted by each processor 13, 69, 79 has a ready access to local data, contained in the databases 6, 66 or 76 of the components 1, 60, 70, irrespective of the operating system of the processor in question and its location in the environment.

In the variant of assembly of components according to the invention shown in FIG. 13, the assembly 130 comprises two components 1 and 60, connected together via their distribution module 46, 47, both connected to the hub 115 of the external environment, an Ethernet physical medium with redundancy in the example being considered.

The component 1 furthermore comprises, in the example described, a processor module 3 connected via a communications bus 13a to a processor 13 of the environment, which is a computer operating under the VxWorks 5.5 operating system. In the example being considered, the component 60 comprises an input/output module 64 connected to discrete physical inputs and outputs 14 of the environment, and a network module 65, connected to a network 15 of the environment, using the Arinc 429 standard.

The processor 13 can thus manage the physical inputs/outputs 14 and the network 15 remotely, by means of the distribution modules 46, 47 and of reading and writing data in the databases 6, 66, as previously described.

The invention is not limited to the examples illustrated. The specific features of the examples illustrated may be combined within variants not illustrated.

Any combination of communications modules 3, 4, 5 is possible. For example, the component 1 according to the invention may comprise several input/output modules and several network modules, which allows a rack of different inputs/outputs to be made available, which are able to transfer their data into the external environment by means of various networks.

The component 1 according to the invention may be presented with a set of certifications in order to respond to the certification requirements of critical applications, such as aeronautics or defense.

The expression “comprising a” is synonymous with “comprising at least one”, except where the contrary is specified.

1. An electronic component with supervised communications modules comprising:
at least two communications modules operating in parallel, and
a supervisor without a microprocessor,
each communications module comprising a stage for interfacing with the supervisor allowing the latter to use a data format common to the assembly of modules,
the supervisor being configured for managing in a deterministic manner the access to a database, as a function of a configuration table and requests to read and/or write in the database, originating from the communications modules.

2. The component as claimed in claim 1, being formed with the aid of one or more programmable logic components.

3. The component as claimed in claim 1, being formed with the aid of one or more programmable logic components of the FPGA or CPLD or ASIC type.

4. The component as claimed in claim 3, in which each communications module comprises a stage for interfacing to an element of the external environment of the component or with the communications module of another component with supervised communications modules, and a link stage between this interfacing stage and the stage for interfacing with the supervisor, allowing the management and the transmission of the data read and/or write requests.

5. The component as claimed in claim 1, in which the communications modules are configured for transmitting the data read and/or write requests to the supervisor via access ports internal to the component.

6. The component as claimed in claim 1, comprising a sequencer allowing the requests originating from the communications modules operating in parallel to be ordered.

7. The component as claimed in claim 1, comprising a time base allowing the adjunction to a data value of its time of receipt by the supervisor during a request to write in the database.

8. The component as claimed in claim 1, in which the supervisor is configured for verifying the validity of a request to read and/or to write a data value by means of an identifier associated with said data value.

9. The component as claimed in claim 1, in which the format for writing in the database contains several encapsulated parameters, notably an identifier of the data value, the time stamp associated with this data value by the time base and the result of a cyclical redundancy control on the data value.

10. The component as claimed in claim 1, in which the supervisor is configured, after the writing and/or the reading of a data value in the database, and as a function of the configuration table, for transmitting a notification to the communications module from which the request to read and/or to write said data value originates.

11. The component as claimed in claim 1, in which the read and/or write requests come from demands on the external environment received by the communications modules and/or from a physical input/output to/from the external environment and/or from a network of the external environment.

12. The component as claimed in claim 1, in which at least one of the communications modules is a processor module executing a software application.

13. The component as claimed in claim 12, in which the processor module is connected to at least one communications bus used by the processor of the external environment, the processor module comprising a stage for interfacing with said communications bus and a link stage between this interfacing stage and the stage for interfacing with the supervisor.

14. The component as claimed in claim 1, in which at least one of the communications modules is an input/output module.

15. The component as claimed in the claim 14, in which the input/output module comprises a stage for interfacing with at least one physical input/output of the environment, notably configured for accessing an analog/digital converter connected to the physical input/output, and a link stage between this interfacing stage and the stage for interfacing with the supervisor.

16. The component as claimed in claim 1, in which at least one of the communications modules is a network module.

17. The component as claimed in claim 16, in which the network module comprises a stage for interfacing with at least one network of the environment, and a link stage between this interfacing stage and the stage for interfacing with the supervisor.

18. The component as claimed in claim 16, comprising several network modules, enabling the connection to be made between various networks of the environment.

19. The component as claimed in claim 1, in which at least one of the communications modules is a distribution module allowing supervisors of various components with supervised communications modules to be connected together.

20. The component as claimed in claim 1, comprising the database.

21. The component as claimed in claim 1, comprising the configuration table.

22. A method of operation of an electronic component with supervised communications modules as claimed in claim 1, comprising at least two communications modules operating in parallel and a supervisor, each communications module comprising a stage for interfacing with the supervisor, in which method:
one of the communications modules of the component transmits a request to read and/or to write data to the supervisor of the component, by means of the stage for interfacing with the supervisor, and
the supervisor, as a function of a configuration table, manages in a deterministic manner the access to a database, in order to read in it and/or to write in it said data.

23. The method as claimed in claim 22, in which the configuration table is loaded during the initialization of the component.

24. The method as claimed in claim 22, in which, prior to writing and/or reading a data value in the database, the supervisor verifies the validity of the request to read and/or to write said data value coming from a communications module.

25. A method of fabrication of an electronic component with supervised communications modules as claimed in claim 1, comprising at least two communications modules and a supervisor without a microprocessor, in which method one or more programmable logic components are programmed in such a manner that the communications modules operate in parallel and that the supervisor manages in a deterministic manner the access to a database, as a function of a configuration table and of requests to read and/or to write in the database, coming from the communications modules.

26. A use of an electronic component with supervised communications modules as claimed in claim 1 in an aircraft.

27. An assembly comprising several electronic components with supervised communications modules as claimed in claim 1, the components each comprising at least one distribution module and being connected together via their distribution module.

28. The assembly as claimed in claim 27, in which one of the components is configured for controlling the synchronization of the dates of all the components by means of a time base shared between all the components.

29. The assembly as claimed in claim 27, in which the data contained in the database associated with a component are configured so as to be accessible by all the components.

30. A method of operation of an assembly comprising several components as claimed in claim 27, said components each comprising at least one distribution module and being connected together via their distribution module, in which method:
following a request for writing a data value from one of the communications modules of a component, and as a function of the configuration table, the distribution module of the component in question transmits the data value to all the other distribution modules of the components, and
the components associated with the identifier of said data value receive it via a write request coming from their distribution module.

31. The method as claimed in claim 30, in which the supervisors of the components send a notification to the other communications modules of the component to which they belong in order to inform said modules of the availability of said data value, upon a request expressed by means of a parameter of the configuration table.

32. The method as claimed in claim 30, in which a component reads, if desired, the data from the communications modules notifying of an available data value.
